(19) United States
(12) Patent Application Publication
(10) Pub. No.: US 2023/0249954 A1
(43) Pub. Date: Aug. 10, 2023

(54) DEVICE FOR GRIPPING A PACKING SECTION

(71) Applicant: L'Air Liquide, Societe Anonyme pour l'Etude et l'Exploitation des Procedes Georges Claude, Paris (FR)

(72) Inventors: Cyrille BABINET, Vitry sur Seine (FR); Eric GALLOPIN, Jouy-en-Josas (FR); Gilles LEBAIN, Vitry sur Seine (FR)

(73) Assignee: L'Air Liquide, Societe Anonyme pour l'Etude et l'Exploitation des Procedes Georges Claude, Paris (FR)

(21) Appl. No.: 18/106,987

(22) Filed: Feb. 7, 2023

(30) Foreign Application Priority Data
Feb. 8, 2022 (FR) FR 2201100

(51) Int. Cl. B66F 9/065; B25J 15/00

(52) U.S. Cl. CPC B66F 9/065; B25J 15/0038; B01D 3/32

(57) ABSTRACT

The present invention concerns a gripping device for gripping a packing section, having a support forming a chassis and retaining means connected to this support and distributed angularly so as to surround the packing section that is to be gripped, characterized in that at least one of the retaining means has movable shoes respectively intended to be in contact with a peripheral edge of the packing section and a plurality of platforms disposed in at least two stages, each platform bearing articulation means able to interact with a platform of a different stage or one of the movable shoes.

### CROSS REFERENCE TO RELATED APPLICATIONS

This application claims the benefit of priority under 35 U.S.C. § 119 (a) and (b) to French patent application No. FR2201100, filed Feb. 8, 2022, the entire contents of which are incorporated herein by reference.

### FIELD OF THE INVENTION

The present invention relates to the field of liquid/gas separation columns and to their assembly, and it concerns more particularly a device for gripping packing sections notably for inserting said packing sections into a casing in order to form these said liquid/gas separation columns.

### BACKGROUND OF THE INVENTION

Gas/liquid separation columns have been known for many years and make it possible, for example, for various chemical elements involved in the composition of a homogeneous fluid to be separated, for example by distillation or by absorption.

The manufacture of a liquid/gas separation column notably comprises a step whereby a packing-section insertion device grips a packing section in order to subsequently insert it into a cylindrical casing. The packing sections are notably used in the columns to ensure the exchange of material and heat between a rising gas and a descending liquid. These packing sections, which notably consist of a superposition of multiple corrugated strips, are often referred to as “packs”. The packing sections are conventionally stacked on one another, if applicable with interposed separators, in order to contribute to the separation of the components of the fluid over the axial dimension of the column.

The insertion device needs to comprise retaining means that allow it to grip a packing section by its sides. The gripping can, however, prove problematic insofar as the casings of the separation columns into which the packing sections are to be inserted do not all necessarily have the same diameter. In that context, the packing sections can have a diameter ranging from 1 m to 5 m, this making it difficult to achieve optimum gripping of an entire range of packing sections.

It is conceivable to use an insertion device adapted to each diameter of packing section, but such a solution requires too much financial investment to be viable.

### SUMMARY OF THE INVENTION

Certain embodiments of the present invention fall in this context and make it possible to envision assembling liquid/gas separation columns for all diameters of packing section using a single gripping device equipped with retaining means that make it possible to adapt to these various diameters.

In certain embodiments, the present invention proposes a gripping device for gripping a packing section, having a support forming a chassis and retaining means connected to this support and distributed angularly so as to surround the packing section that is to be gripped, characterized in that at least one of the retaining means has movable shoes respectively intended to be in contact with a peripheral edge of the packing section and a plurality of platforms disposed in at least two stages, each platform bearing articulation means able to interact with a platform of a different stage or one of the movable shoes.

According to certain embodiments of the invention, the retaining means has a configuration with a plurality of stages of articulated elements which makes it possible to provide an infinite number of configurations of the gripping device and to find the configuration that is adapted to the diameter of the packing section that is to be gripped. The positions of the shoes that are intended to be in contact with the packing section can be adjusted in relation to one another with greater finesse owing to an articulation of each of the mutually articulated elements, stage by stage.

According to another optional feature of the invention, the retaining means are arranged in relation to one another so as to form a circle, the said retaining means being evenly distributed angularly. In this way, the retaining means can be in contact with the peripheral edge of a packing section having the shape of a straight cylinder and the compressive forces exerted on the packing section can be evenly distributed.

According to another optional feature of the invention, the gripping device has six retaining means.

According to another optional feature of the invention, each retaining means has a base platform which is connected to the support of the gripping device and bears an assembly of articulation means able to interact with first additional platforms forming a first stage of platforms of the gripping device. The various stages of platforms and shoes of the retaining means thus all bear against the base platform, which makes it possible to ensure the retaining means is fixed to the support, the latter being either specific to this retaining means or common to all the retaining means.

According to another optional feature of the invention, the first additional platforms each have articulation means able to interact respectively with second additional platforms, forming a second stage of platforms of the gripping device, or movable shoes.

According to another optional feature of the invention, the movable shoes are mounted so as to be able to pivot on platforms of one and the same stage of platforms of the gripping device. In other words, the platforms are disposed next to one another so as to form a final stage, or distal stage, that is to say the stage that is furthest away from the base platform and intended to be in contact with the packing section that is to be gripped.

According to another optional feature of the invention, the movable shoes have a retaining surface which can be inscribed in a straight plane, tangent to the peripheral edge of the packing section that is to be gripped. In other words, if consideration is given to a radial direction extending from the support to the packing section, each retaining surface can be inscribed in a straight plane substantially perpendicular to this radial direction, so as to define point contact or linear contact between the shoe and the peripheral edge of the packing section.

According to another optional feature of the invention, the gripping device has a motorized system configured to drive the radial movement of the base platform, the said motorized system being inserted between the base platform and the support of the gripping device.

The motorized system, which can notably be a stepping electric motor, is notably intended to manage the spacing between the corresponding retaining means and the packing section in order to manage the clamping pressure of the shoes against the peripheral edge of this retaining means. Where appropriate, the use of the motorized system can make it possible to adjust a specific compressive stress at the corresponding retaining means.

According to another optional feature of the invention, the support has the form of a polygonal frame, which has as many sides as the gripping device has retaining means, each retaining means being fixed on the inside of the support at a vertex of the polygonal frame.

According to another aspect of the invention, the invention concerns an insertion device for inserting at least one packing section into a cylindrical casing, wherein a deployment module has a main member centred around a main axis of the insertion device, and a plurality of peripheral members arranged circumferentially and evenly around the main axis, each of the peripheral members contributing to forming the support of the gripping device as described above, by bearing a respective one of the retaining means configured to grip a packing section, the deployment module being able to modify the dimension of the insertion device in order to adjust the position of the retaining means around the packing section that is to be gripped, by modifying a radial distance between the main member and each of the peripheral members.

By virtue of the insertion device according to this other aspect of the invention, and more particularly by virtue of the deployment module, the retaining means can grip any type of packing section, of any diameter. Before gripping the packing sections, the deployment module is set up in such a way as to define the radial distance between the main member and the peripheral members, and thus position the retaining means, which are arranged on the peripheral members, relative to one another in such a way as to form a pattern, notably a circular pattern, of dimensions that complement the periphery of the packing section that is to be gripped. The radial distance between the main member and each of the peripheral members is the same, so as to obtain a virtual diameter defined by the circular shape assumed by the retaining means and adapted to the diameter of the packing sections.

It is particularly advantageous to equip such an insertion device with a gripping device as mentioned above, in order that the articulated means, that is to say the platforms and/or the shoes, that are provided in this gripping device can adapt the profile of the gripping device to the dimension of the packing section that is to be gripped. The shoes can be correctly pressed against the periphery of the packing section that is to be gripped, irrespective of its diameter.

The peripheral members are all parallel or substantially parallel to the main axis. The retaining means may be arranged on all of the peripheral members or on just some of them.

According to one feature of the invention, the insertion device for inserting at least one packing section into a cylindrical casing can be combined with a bearing structure, thus forming an insertion system which performs additional functions, such as the movement of the insertion device.

The bearing structure takes the form of a gantry which is able to move in at least one direction while bearing the insertion device gripping a packing section. In order to carry out such a movement, the bearing structure can, for example, be arranged on rails so that the movement takes place in the most precise possible direction.

Such an insertion system makes it possible to grip packing sections of various diameters and then insert them into a casing arranged horizontally.

According to one feature of the invention, the insertion device is able in its entirety to move in translation relative to the bearing structure. Independently of the bearing structure, the insertion device can move, for example, in a vertical manner. This vertical movement is useful, for example, for positioning the insertion device in line with a stack of packing sections and then for lowering it for the purpose of gripping the packing section disposed at the top of the stack. The vertical movement of the insertion device with respect to the bearing structure is also useful for the purpose of adjusting the position of the gripped packing section in order to correctly position the latter at the inlet of the casing and thus to promote pushing of the packing section into the casing. The relative movement of the insertion device with respect to the bearing structure can, for example, take place using a motor installed on the bearing structure and configured to move a bearing element of the insertion device along the bearing structure.

According to one feature of the invention, the insertion device is able in its entirety to rotate relative to the bearing structure. The rotation makes it possible notably to tilt the insertion device, with a bearing structure which remains fixed, between a position in which the insertion device is arranged in a vertical manner for the purpose of gripping a packing section on a vertical stack of packing sections, and a position in which the insertion device is arranged in a horizontal manner for the purpose of inserting the gripped packing section into the casing. The rotation elements must therefore be configured to enable a rotation of the insertion device by approximately 90° so that the insertion device can tilt between the abovementioned vertical and horizontal positions. The relative rotation of the insertion device with respect to the bearing structure can, for example, occur by means of a motor able to control a gear system driving the rotation of the insertion device, or else via a chain system or a hydraulic system.

Certain embodiments of the invention also cover a method for inserting at least one packing section into a cylindrical casing, which method is implemented by an insertion system as described above and comprises:
a step of adjusting the radial distance between the main member and the peripheral members of the deployment module,
a step of gripping a packing section by the retaining means of the insertion device,
a step of positioning the packing section at an inlet of the casing,
a step of relaxing the grip on the packing section by the retaining means,
a step of pushing the packing section into the casing.

The steps of the method are carried out using the various elements of the insertion system that were mentioned above. Notably, and as already described above, the deployment module performs the step of adjusting the radial distance between the main member and the peripheral members and the step of gripping is performed using retaining means of the insertion device. At the end of the method, the pushing step can be performed using telescopic devices that insert the packing section into the casing. It should be noted that this is a non-exhaustive list of steps for the correct progress of the method for inserting packing sections into the casing according to the invention. By way of non-limiting example, the method according to the invention may include a step of monitoring the correct positioning of the packing section once inserted into the casing. This additional step, coming here after the pushing step, then consists in verifying and recording the correct position of the packing section which has just been inserted, using a measuring apparatus which is accurate to the millimetre.

### BRIEF DESCRIPTION OF THE DRAWINGS

Other features and advantages of the invention will become further apparent via, on the one hand, the following description and, on the other hand, several exemplary embodiments given by way of non-limiting indication and with reference to the attached schematic drawings, in which:

FIG. 1 is a general view of an insertion device, here connected to a bearing structure, during the insertion of a packing section into a casing, the insertion device being equipped with a gripping device according to the invention and with the retaining means in a disengaged position here;

FIG. 2 shows the insertion device of FIG. 1, here without the connected bearing structure, with a deployment module for modifying the radial spacing of the gripping means, two retaining means of this gripping device being visible here in an active position of gripping a packing section;

FIG. 3 is a schematic representation of one of the retaining means of the gripping device according to one embodiment of the invention, this retaining means comprising multiple stages of platforms and a plurality of shoes intended to be in contact with the packing section to be gripped;

FIG. 4 is a schematic representation, in section in a plane parallel to an axis about which the retaining means of the gripping device are arranged, of part of a retaining means, notably showing the specific shapes of the platforms and of a shoe of this retaining means;

FIG. 5 is a schematic representation similar to that of FIG. 3, in which one of the platforms and the shoes it bears have been shown in a hypothetical position to illustrate their pivotable mounting;

FIG. 6 shows the retaining means of FIG. 3 in a first configuration, in which it is able to grip a packing section of a first diameter;

FIG. 7 shows the retaining means of FIG. 3 in a second configuration, in which it is able to grip a packing section of a second diameter;

FIG. 8 is a schematic representation of a motorized system of the gripping device that makes it possible to position a retaining means in a disengaged position or in an active position of gripping a packing section, the motorized system being disposed in this instance in a member specific to the retaining means;

FIG. 9 shows a variant of the gripping device of the invention, in which the retaining means, in this instance similar to that of FIG. 3, is connected to a hexagonal support common to each of the retaining means;

FIG. 10 shows a step of gripping a packing section of a method for inserting packing sections;

FIG. 11 shows a step of rotating the insertion device and moving the insertion system of the method for inserting packing sections;

FIG. 12 shows a step of inserting the packing section of the method for inserting packing sections.

### DETAILED DESCRIPTION OF THE INVENTION

It will be recalled that certain embodiments of the invention concern retaining means, which form a device for gripping a packing section. More particularly, the invention concerns a gripping device having a structure forming a chassis and retaining means connected to this structure and evenly distributed so as to surround the packing section that is to be gripped, one or more of the retaining means having articulated elements, disposed in stages, so as to be able to take multiple respectively optimum configurations for a precise dimension of a packing section that is to be gripped. A detailed example of these articulated elements will be given below.

Furthermore, the gripping device will be described in an application for a system for inserting a packing section into a casing, but it should be noted that the example of an insertion system which will be described more particularly does not limit the invention. The retaining means of the gripping device may thus be borne by a support of the insertion system which both transports the packing section to face the casing and then pushes this packing section into the casing, or else by a support which operates only during the transport of the packing section, this packing section being pushed into the casing by another device.

Firstly, a description will be given of the gripping device according to the invention in its application in an insertion system 1, which is able for the one part to transport the packing section to face the casing, by implementing the gripping device, and then to push this packing section into the casing once the gripping device has disengaged from the packing section.

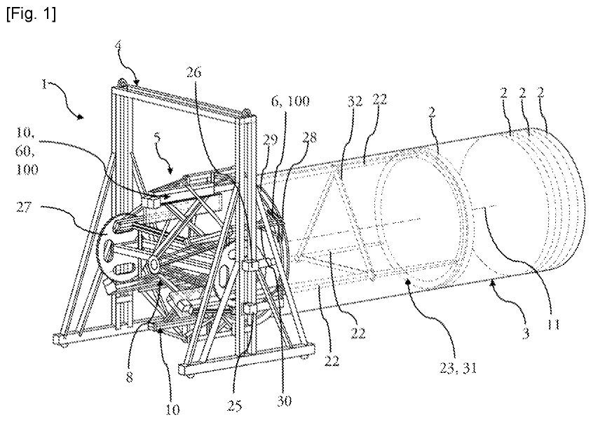

FIG. 1 shows such an insertion system 1 for inserting packing sections 2 into a casing 3, said insertion system being used notably for the purpose of forming a gas/liquid separation column. Such separation columns take, for example, a cylindrical shape of circular or substantially circular cross section. The separation columns may have a main dimension of several tens of metres and a cylindrical cross section of several metres. The packing sections 2 that are intended to be inserted into these separation columns may have a circular or substantially circular cross section of a diameter of around 1 m to 5 m.

Here, the insertion system 1 makes it possible to horizontally insert packing sections into the casing, something which can notably be advantageous for reasons of mechanical bulk in terms of height that make the operation of inserting the packing sections impossible when the casing is arranged vertically. It should, however, be noted that this arrangement of the insertion system and the inserting of the packing sections 2 in a horizontal direction as illustrated could be different without departing from the context of the invention, provided that the insertion system has a deployment module as will be described below.

The insertion system 1 for inserting packing sections according to the invention makes it possible to carry out a method for inserting said packing sections 2 into the casing, which will be described in more detail below with reference to FIGS. 10 to 12. Such an insertion system 1 notably makes it possible to grip a packing section 2 on a vertical stack 24 of packing sections, as illustrated in FIG. 10. The insertion system 1 then makes it possible to perform a rotation in order to arrange the packing section 2 to face an entrance to the casing, to move up to the entrance to the casing, and then to push the packing section 2 up to the bottom of the casing or against another packing section 2 already inserted into the casing, with a progression which is as fluid as possible, that is to say with the fewest possible jolts, of the packing section 2 inside the casing.

In order to achieve this, the insertion system 1 comprises a bearing structure 4 and also an insertion device 5 which is arranged on the bearing structure 4 and notably comprises retaining means 6 for gripping the packing sections 2.

According to the invention, these retaining means 6 form part of a gripping device 100 configured to be able to effectively grip a packing section irrespective of its diameter, as will be described in more detail below.

The bearing structure 4 takes the form of a gantry comprising two pillars 7 between which the insertion device 5 rests. The bearing structure 4 may for example be mounted on rails in order that the insertion system 1 can perform a linear movement between the stack 24 of packing sections 2 and the casing.

In the example illustrated, the insertion system 1 comprises a first motor 25 enabling the insertion device 5 in its entirety to carry out a translational movement relative to the bearing structure 4. The insertion system 1 also comprises a second motor 26 for actuating a gear system 27 for moving the insertion device 5 in its entirety so as to carry out a rotation relative to the bearing structure 4. This rotation makes it possible to switch the insertion device from a vertical position to a horizontal position so as to be able to arrange the packing section 2 to face the entrance to the casing, as mentioned above.

As mentioned above, the diameter of the packing sections can vary between 1 m and 5 m. Before the packing sections are gripped, it is important to be able to adapt the insertion device to the diameter of the packing section in question in order that the retaining means can face the peripheral edge 75 of the packing sections 2 and be able, by way of their particular structure which will be described below, to grip the packing sections optimally and as reliably as possible. Thus, before proceeding with the step of gripping the packing section in the course of the method for inserting same, the insertion device needs to be suitably dimensioned.

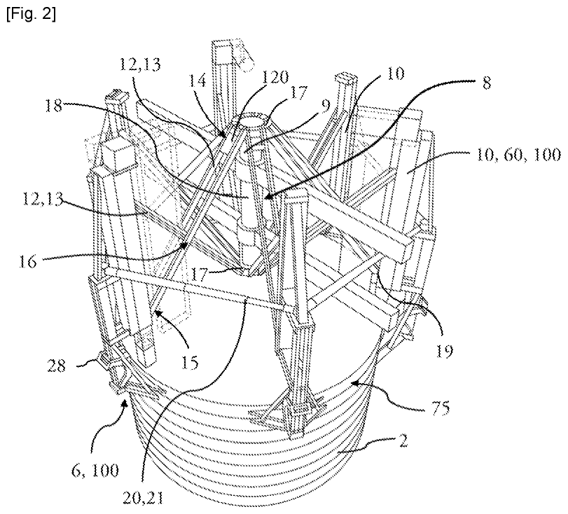

To do this, the insertion device 5 comprises a deployment module 8 comprising the retaining means 6. More specifically, the deployment module 8 comprises a main member 9 and a plurality of peripheral members 10 parallel to the main member 9. The main member 9 extends mainly along a main axis 11 passing through the centre or substantially through the centre of the gripped packing section 2. The peripheral members 10 are arranged circumferentially and evenly around the main member 9. The abovementioned retaining means 6 are arranged at the peripheral members 10. The deployment module 8 comprises at least two peripheral members 10. Advantageously, and as notably can be seen in FIG. 2, the deployment module comprises at least six peripheral members.

Each peripheral member 10 is mechanically connected to the main member 9 by two branches 12 forming a pair of branches 13. Each of the two branches 12 comprises a first end 14 connected to the main member 9 and a second end 15 connected to the peripheral member 10. Moreover, the two branches 12 of the pair of branches 13 intersect one another and are connected to one another at their point of intersection, that is to say substantially in their centre, by a pivot connection 16. In the example illustrated, each branch 12 is formed of two parallel members secured to one another by a spacer 120, these spacers maintaining the mutual separation of the branches. For one pair of branches 13, the branches 12 have a different separation between their members, so that a first branch, the members of which are farther separated than those of the second branch, flanks the second branch at the point of intersection. The members of one of the branches each have a pin that is directed towards the members of the other branch and is able respectively to engage in a corresponding orifice formed in one of the members of the other branch.

It is notably by virtue of the pairs of branches 12 of the deployment module 8, and more particularly by virtue of the modification of an inclination of the branches of each pair of branches, that a radial distance between the main member 9 and the peripheral members 10 can be adjusted and that the retaining means 6, arranged on the said peripheral members 10, can thus be brought closer towards or moved further away from the main axis according to an adaptable diameter, thus ensuring compatibility with a wide range of packing-section diameters. This modification of the radial distance is done between the main member and all of the peripheral members simultaneously. Details regarding the operation of the deployment module will be described below.

By virtue of the deployment module, the retaining means are thus positioned, and notably separated relative to one another, in order to correctly take hold of the packing section, irrespective of its diameter.

Once the desired radial distance has been established, this can be fixed by a locking means 20. The locking means 20 may for example be associated with a plurality of deployable rods 21 extending between two adjacent peripheral members 10, as illustrated in FIG. 2.

Owing to the packing section 2 being grasped by the edge surface, associated with the fact that the packing sections 2 have a cylindrical shape of circular or substantially circular cross section, the retaining means 6 forming part of the gripping device 100 according to the invention are arranged in relation to one another so that together they take the shape of a circular arc, in order that each of the retaining means 6 intended to be in contact with the packing section 2 can closely follow a radius of curvature of the latter. The gripping of the packing section 2 is thus facilitated and more stable. In order that the gripping of the packing section 2 by the retaining means 6 is optimal, the curvature of the circular arc formed by the retaining means 6 is adjustable in order to adapt to all diameters of packing sections 2, as will be described in more detail below.

After the packing section 2 has been gripped by the retaining means 6 of the gripping device, said retaining means can be controlled individually in relation to one another for the purpose of pushing against a precise point of the packing section 2 and locally deforming the latter. Such a local deformation may be recommended when there is a shape differential between the packing section 2 and the casing into which the packing section 2 is intended to be inserted. The local deformation thus makes it possible to slightly modify the shape of the packing section 2 so that it can then be inserted more easily into the casing. The local deformation is notably made possible by controlling a motorized system associated with each of the retaining means, and these too will be described in more detail below.

At least two peripheral members 10 each comprise a hook 28. When the insertion device 5 is disposed near the casing 3 with a view to subsequently inserting a packing section 2 therein, the hooks 28 close over the casing 3, for example over a flange 29 extending circumferentially around the casing 3 at the end of the casing 3 via which the packing sections 2 are inserted. The hooks 28 thus mechanically hold the casing 3 facing the insertion device 5, including during the insertion of the packing section 2 into the casing 3. The presence of these hooks 28 makes it possible to realize a counterweight sufficient to retain the casing 3 in spite of the forces exerted thereon during the insertion of the packing sections 2. The hooks 28 thus avoid the need for a bulky counterweight disposed to the rear of the casing 3 to arrest it while the packing section 2 is being pushed.

In order to be able to close over the flange 29 of the casing 3, the hooks 28 need to extend along each of the peripheral members 10, beyond the retaining means 6 also borne by the peripheral members 10. This extension can create a mechanical impediment when the retaining means 6 are gripping a packing section 2 on the stack of packing sections, particularly when it is the last packing section 2 of the stack that is being gripped, because the hooks 28 can then butt against the ground. In order to alleviate this problem, each of the hooks 28 is mounted on a retractable ram 30 in order to retract the hooks 28 and avoid any mechanical stress linked to a deployed hook 28. The hooks 28 are thus able to move between a retracted position, notably when the insertion device 5 is in a vertical position for gripping the packing sections 2, and a deployed position that makes it possible to fix the insertion device 5 to the casing 3 when the gripped packing section 2 is being held at the end of the casing 3. When the hooks 28 are in the deployed position, they are configured to avoid any mechanical interference with the retaining means 6 disposed on the same peripheral member 10. In order to avoid the said mechanical interference, the hooks 28 may have a particular shape and/or may retract and extend pivoting about the peripheral member 10 in question, the pivoting being away from the main member so as not to come into contact with the retaining means 6.

At least two of the peripheral members 10 are provided with telescopic devices 22. The telescopic devices 22 can be arranged on a peripheral member 10 also provided with a retaining means 6, the essential thing being that all of these elements do not mechanically interfere with one another. The telescopic devices 22 make it possible to push on the packing section 2 once the latter has been placed facing the casing. This pushing is performed once the gripping device 100 is configured such that the retaining means 6 are in a disengaged position, that is to say once suitable motorized systems make it possible to transfer each of the retaining means from an active gripping position to a disengaged position by modifying their radial position, such that the retaining means release the packing section 2. The telescopic devices 22 deploy in order to push the packing section 2 up to the end of the casing, regardless of the length thereof. If one or more packing sections 2 have already been previously inserted into the casing, the telescopic devices push the packing section 2 until the latter is in contact with the previously inserted packing section 2.

In order for the packing section 2 to be inserted uniformly into the casing, with the minimum of jolts, the insertion device 5 may comprise a pushing means 23 fixed to the end of each telescopic device 22, as is more particularly visible in FIG. 1, this pushing means being intended to be in direct contact with the packing section 2 as it is being inserted. The pushing means 23 mechanically distributes the forces exerted by each of the telescopic devices 22 by bearing on the whole periphery of the packing section 2 so as to avoid the localization of the forces only at the end of the telescopic devices 22. The pushing means 23 thus makes it possible to avoid damaging the inserted packing section 2 on account of a localized pushing force. When the telescopic devices 22 are collapsed, the pushing means 23 is arranged in the vicinity of the peripheral members 10. The telescopic devices and the pushing means constitute one example of means for inserting the packing section, but the latter could be inserted in other ways and with other means without departing from the context of the invention, provided that the insertion device employs a deployment module in accordance with the invention.

By way of example, as illustrated in FIG. 1, the insertion device 5 comprises six peripheral members 10, three of which are provided with telescopic devices 22. The telescopic devices 22 are distributed evenly around the main axis 11.

In order to insert packing sections 2 that may reach significant diameters, each of the telescopic devices 22 has a pushing force of at least 1 t. This pushing force is distributed over the entire periphery of the packing section 2 by the pushing means 23.

The telescopic devices 22 deploy when the packing section 2 is positioned facing the entrance to the casing 3. When the insertion of the packing section 2 is initiated, the pushing means 23 is driven by the deployment of the telescopic devices 22 and comes into contact with the packing section 2. The area in which the pushing means 23 makes contact with the packing section 2 corresponds at least to a peripheral annular area 31 of the packing section 2 that is pushed. The peripheral annular area 31 thus faces a periphery of the packing section 2, that is to say is in the vicinity of an edge of the packing section 2.

As the packing section 2 is being pushed, the force exerted by the telescopic devices 22, and by analogy by the pushing means 23, is preferably localized at the periphery of the packing section 2, because it is at the periphery that the forces opposing the pushing arise, notably the friction forces of the packing section 2 against the walls of the casing 3. The pushing carried out in the peripheral annular area 31 therefore makes it possible to compensate for the friction forces exerted on the packing section 2 when it is being inserted into the casing 3. The compensation for the friction forces is particularly effective if the insertion device is equipped with a pushing means 23 as has just been described, because the latter is arranged as close as possible to the location of these friction forces. As illustrated in FIG. 1, the pushing means 23 advantageously has an annular shape, the radial dimension of which corresponds to the dimension of the peripheral annular zone 31 of the packing section 2.

Because the deployment module enables adaptation to various diameters of packing section 2, multiple pushing means 23 of different dimensions are envisioned, and the appropriate pushing means 23 is installed once the appropriate radial distance between the main member and the peripheral members 10 has been determined.

Despite the even distribution of the telescopic devices 22 and the presence of the pushing means 23, it is possible that a friction force exerted on the packing section 2 as it is being inserted might be of greater intensity locally. This localized friction force may be due to a horizontal position of the casing 3 and/or that of the packing section 2. Gravity may also cause the packing section 2 to press more heavily against the wall of the casing 3, thus giving rise to asymmetry in the resulting forces of contact between the packing section 2 and the casing 3. Other factors that generate a localized friction force can also come into play, such as, for example, a surface finish of the wall of the casing 3 or a surface finish of the edge surface of the packing section 2. In order to even out the pushing force, each telescopic device 22 may be controlled individually in relation to one another in order to intensify one or another of the pushing forces so as to compensate for an elevated local friction force. In order to detect these local friction forces, each end of each telescopic device 22 may for example comprise a resistance sensor that measures the friction forces and therefore is able to detect an elevated friction force.

When the telescopic devices 22 deploy to push the packing section 2 into a casing 3 having a great length, for example several tens of metres, the telescopic devices 22 deploy until reaching a considerable length which can harm their stability. The insertion device 5 can therefore comprise a holding member 32 connected to all of the telescopic devices 22 and arranged so as to be substantially at an equal distance between the pushing means 23 and the entrance to the casing 3. The function of the holding member 32 is to maintain the position of each of the telescopic devices 22 and also the distance between each of them. The holding member 32 therefore contributes to the distribution of the forces exerted on the inserted packing section 2. The holding member 32 also ensures the stability of the telescopic devices 22 by avoiding potential bending thereof that may arise in the case of extension to a great length of the said telescopic devices 22. As is illustrated in FIG. 1, the holding member 32 has a triangular shape in order to maintain three telescopic devices 22 evenly distributed around the main axis 11. However, the shape of the holding member 32 can vary depending on the number of telescopic devices 22 included in the insertion device 5. In a variant which has not been shown, the holding member 32 can have a set of casters, each disposed as an extension of the branches of the holding member, beyond the telescopic devices, which are respectively in contact with the inner face of the peripheral wall of the casing. The aim is then to ensure continuous guidance of the holding member within the casing during the deployment of the telescopic devices and the insertion of a packing section. This continuous guidance, by contact of at least one of the casters against the casing, makes it possible to facilitate the insertion in spite of the weight of the assembly formed by the telescopic arms and the pushing means 23 that could cause the assembly to become misaligned. Alternatively or additionally, the pushing means can also have one or more casters arranged at the periphery in order to be in contact with the inner face of the tubular wall of the casing during the insertion of the packing sections into the casing.

FIG. 2 more particularly reveals the deployment module, shown here without the associated bearing structure. The operation of the deployment module will be described more specifically with reference to this figure, and a description will be given notably of the way in which the radial distance between the main member and the peripheral members is modified.

The main member 9 comprises two fixed rings 17, each of the fixed rings 17 being arranged at each terminal portion of the said main member 9. The main member 9 comprises a telescopic body 18 able to modify a main dimension of the main member 9. Thus, by modifying the length of the main member 9, it is possible to increase or reduce the distance between the two fixed rings 17. The length of the main member 9 can be adjusted manually or via a control member which has not been shown. The telescopic body 18 makes it possible to modify the length of the main member 9 by deploying or retracting at least one of the terminal portions thereof.

The first end 14 of each branch 12 of the pair of branches 13 connecting the main member 9 to one of the peripheral members 10 is more particularly connected to one of the fixed rings 17 arranged on the main member 9. Each pair of branches 13 thus comprises a first branch 12, the first end 14 of which is connected to a first fixed ring 17, and a second branch 12, the first end 14 of which is connected to a second fixed ring 17. The second end 15 of the two branches 12 is for its part fastened to the peripheral member 10 and at least one of them can slide along the latter, for example by means of a slideway 19 formed at one of the faces of the peripheral member 10. In the example illustrated, two slideways 19 are shown such that each of the two ends 15 are mounted so as to be able to slide along the corresponding peripheral member.

Thus, when the length of the main member 9 is modified by virtue of the telescopic body 18, the distance between the fixed rings 17 and, therefore, the distance between the first ends 14 of each of the two branches 12 are also modified. With the branches 12 being connected at a point forming a pivot connection 16, this point tends to move towards or away from the main member 9 depending on the first ends 14 moving away from one another or moving towards one another. The movement of the telescopic body 18 thereby causes a modification of the inclination of the branches 12 of each of the pairs of branches 13 and thus modifies the radial distance between the main member 9 and the peripheral members 10.

As has been mentioned above, the function of the deployment module 8 is thus to modify a radial distance between the main member 9 and each of the peripheral members 10, the retaining means 6 for of the gripping device 100 for gripping the packing section being arranged on the said peripheral members 10, whether or not they are associated with telescopic devices 22 as mentioned above and in respect of which a telescopic-device actuating unit has been shown in dotted line in FIG. 2. The retaining means 6 can thus be spaced apart in order to be able to engage around packing sections 2 of various diameters. The greater the length of the main member 9, the more the fixed rings 17 are moved away from one another, and the closer are the peripheral members 10 to the main member 9, adapting the insertion device 5 to a small diameter of a packing section 2. Conversely, the lower the length of the main member 9, the more the fixed rings 17 are moved towards one another, and the further away are the peripheral members 10 from the main member 9, adapting the insertion device 5 to a large diameter of a packing section 2. The deployment module 8 as has just been mentioned therefore makes it possible to adapt the insertion device 5 to a plurality of diameters of packing sections 2 and casings.

A more detailed description will now be given of the gripping device 100 according to the invention, with reference notably to FIGS. 2 to 8.

FIG. 2 notably reveals various parts described above that contribute to forming the gripping device, specifically a plurality of retaining means 6 and a support 60, which in this instance is formed by the peripheral members 10 of the deployment module 8. As was mentioned above, the retaining means 6, of which there are six here, are disposed in a circular shape, evenly spaced apart from one another, so as to produce an even engagement on the packing section 2 that is to be gripped.

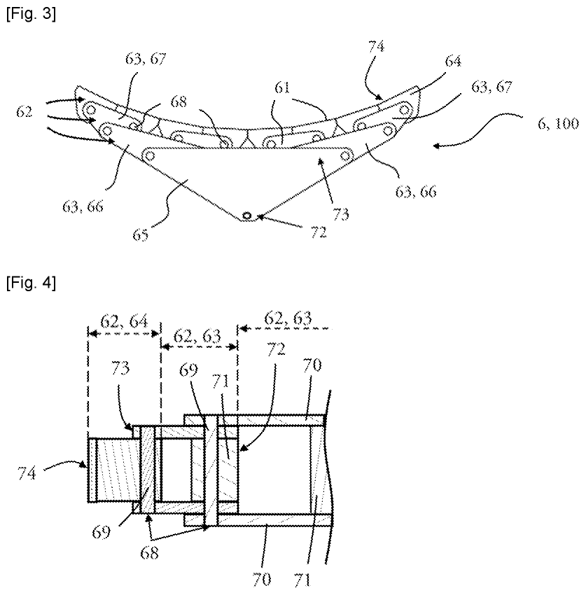

One retaining means 6 can be seen more particularly in FIG. 3. It has multiple articulated elements 61 arranged in successive stages 62, including a plurality of platforms 63 serving as support for the articulation of elements of the following stage, and a plurality of shoes 64 that form the last stage of the retaining means 6 and are intended to be in contact with the packing section 2 that is to be gripped.

In this instance, the retaining means 6 has three successive stages 62, which all extend radially one after another from a base platform 65 disposed in the vicinity of the support. A first stage 62 is formed by two platforms, in this instance two first additional platforms 66, respectively mounted articulated on the base platform 65. A second stage 62 is formed by four platforms, in this instance four second additional platforms 67, mounted articulated in pairs on each of the first additional platforms 66 of the first stage. A third stage 62 is formed by the shoes 64 respectively mounted articulated on one of the second additional platforms 67 of the second stage.

Each platform 63 has at least one articulation means 68, in this instance two articulation means, that is able to interact with a platform, or a shoe if appropriate, of the following stage and more particularly with an articulation shaft 69 of this platform or of this shoe.

More particularly, each platform 63 is formed of two plates 70 superposed on one another and a spacer 71 disposed between the two plates at one end of the platform 63 and intended to keep the two plates 70 at a distance from one another. That end of the platform at which the spacer 71 is disposed will be referred to below as proximal end 72, because this end, when the gripping device 100 is assembled, is that end of the platform 63 that is closest to the support 60 of the gripping device 100. At the opposite radial end, specifically the distal end 73, the platform 63 is open such that a platform of the following stage 62 or a shoe 64 can be housed between the plates 70 of this platform 63. To that end, it should be understood that the height, that is to say here the dimension in the direction of superposition of the plates 70 and thus in a direction perpendicular to the plane of extension of the plates, of a platform of a given stage 62 is greater than the corresponding dimension of a platform or a shoe of a different stage 62 further away from the support 60.

As can be seen in FIGS. 3 and 4, each platform 63 has a substantially triangular shape with a vertex at the proximal end 72 and two vertices at the distal end 73. At each of the vertices, articulation means 68 are provided to interact with one of the other articulated elements 61 of the retaining means 6.

In the example illustrated, the two distal vertices have orifices able to receive an articulation shaft 69 of another articulated element 61 and the proximal vertex has a protruding articulation shaft 69 for interacting with another articulated element 61 or with the support 60 in the case of the base platform 65. More particularly, at the proximal end 72 of a platform or of a shoe, the spacer is passed through by an articulation shaft 69 which projects axially beyond either side of the plates 70 so as to form axial protrusions.

FIG. 4 more particularly reveals the structure of one of these platforms 63, in this instance forming a stage of platforms disposed between other platforms 63 and the final stage of shoes 64. As has been mentioned above, the articulation shaft 69 secured to this platform 63 forms two protrusions on either side of the plates 70 so as to be housed in corresponding orifices of the platform 63 receiving it, and this platform 63, at an opposite radial end, or distal end 73, has articulation means 68 in the form of orifices able to receive an articulation shaft 69, in this instance secured to a shoe 64. At each of these ends, the articulation shaft and the orifices interact so as to enable the rotational movement around the articulation shaft of the corresponding articulated element.

At least one shoe 64 forming the distal stage, or final stage, of the gripping device 100 has a retaining surface 74 facing away from the stages of platforms 63. The retaining surface 74 may be formed by a coating layer made of a material different from that of the rest of the shoe. As an alternative or in addition, it may have microstructures, for example in the form of studs, to improve the retention of the packing section 2.

Each retaining surface 74 can be inscribed in a straight plane, and more particularly a plane perpendicular to the radial direction along which the stages of articulated elements of the retaining means follow one another. In other words, the retaining surface 74 intended to be in contact with a cylindrical peripheral edge may advantageously have a straight, non-curved shape, at the very least when it is at rest, that is to say when the shoe 64 is not pressed against the packing section 2. Each shoe 64 thus has a point of contact with the peripheral edge 75 of the packing section, which tends to enlarge under the effect of the pressure exerted on the shoe against the packing section during the gripping step, and the plurality of shoes 64 disposed next to one another in the final stage 62 of the retaining means makes it possible to create a contact profile, point of contact by point of contact, which takes the straight cylindrical shape of the packing section.

The articulations 68, 69 formed between two platforms 63, or between a platform 63 and a shoe 64, are adjusted such that it is possible for one to pivot in relation to the other under stress, but that the elements 61 thus articulated can keep a position substantially equal to their theoretical position without stresses. In other words, each retaining means 6 keeps substantially the shape illustrated in FIG. 3 until the shoes 64 come into contact with the peripheral edge 75 of the packing section 2 that is to be gripped and until they are made to pivot in relation to the platform 63 that bears them, these platforms 63 being able in turn to be made to pivot in relation to the platforms 63 that bear them.

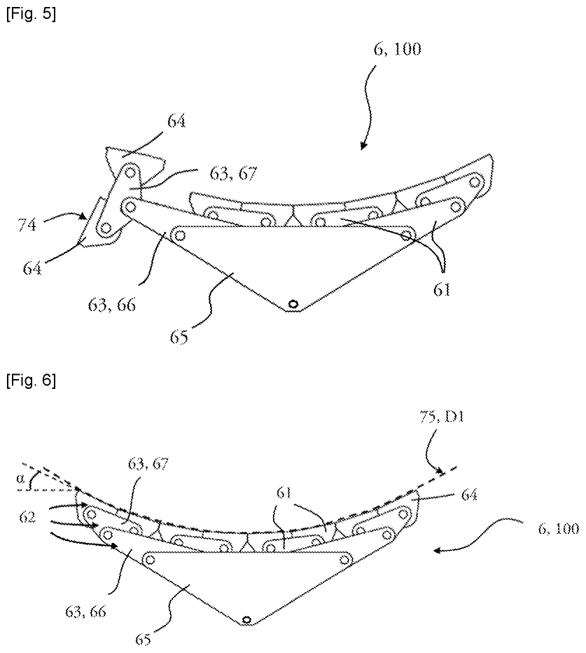

In other words, the articulation of the articulated elements 61 is controlled, and therefore the example given in FIG. 5 is only theoretical in order to facilitate the reader's understanding of the subject of this notion of articulation of a shoe and a platform. By way of illustration, in this FIG. 5, the two platforms, or first additional platforms 66, connected to the base platform 65 keep the same orientation, and the same applies for three of four platforms, or second additional platforms 67, of the last stage of platforms. A single platform 63, here at one end of the retaining means 6, is pivoted substantially by 90° and similarly, by way of illustration, a single one of the two shoes 64 borne by this platform 63 is also pivoted, in this instance in an exaggerated manner substantially by 90°, so as to illustrate the independent pivoting of each of the shoes in relation to the platform that bears them.

The plurality of stages 62 of articulated elements 61 makes it possible to modify the configuration of the gripping device 100 according to the diameter of the packing section 2 that is to be gripped.

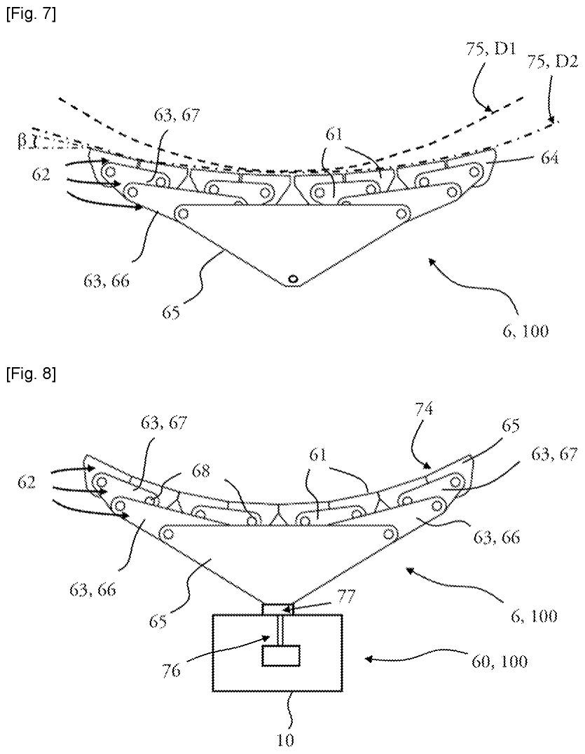

In this way, and as is illustrated in FIGS. 6 and 7, the shoes 64 forming the distal stage, that is to say the stage furthest away from the support 60 and therefore closest to the packing section 2 that is to be gripped, can be more or less flat and therefore locally, shoe by shoe, have a shape which substantially complements the radius of curvature of a given packing section.

By way of example, the dimension of a shoe in relation to a packing section, considering the dimension taken in a plane of section of the packing section that is perpendicular to its axis of revolution, is around 160 mm in relation to a diameter of between 1 m (one metre) and 5 m (five metres) for the packing section.

FIG. 6 reveals, in dashed line, part of the peripheral edge 75 of a first packing section 2 that is able to be gripped by the gripping device 100 of the invention in a first configuration, and notably with shoes 64 which have a significant angle of inclination a, with a value in this instance substantially equal to 45°, between the shoes disposed in the centre of the series of shoes and the shoes disposed at the end of this series. In this configuration, packing sections of a first diameter D1 are gripped optimally by shoes of the order of magnitude mentioned above, it being possible for this first diameter D1 notably to be around 1 m, for example.

FIG. 7 reveals the same retaining means 6 in another configuration, since it is in contact with a packing section 2 of a different diameter than that illustrated in dashed line in FIG. 6. FIG. 7 illustrates part of the peripheral edge 75 of a second packing section that is able to be gripped by the gripping device of the invention, in chain-dotted line, in a second configuration, and notably with shoes 64 which this time have a reduced angle of inclination J, with a value in this instance substantially equal to 20°, between the shoes disposed in the centre of the series of shoes and the shoes disposed at the end of this series. In this configuration, packing sections of a second diameter D2 are gripped optimally by shoes that are unchanged in relation to the configuration illustrated in FIG. 6, it being possible for this second diameter D2 notably to be around 4 m or 5 m.

The fact that the retaining means 6, as mentioned above, has a plurality of articulated elements 61 arranged in multiple successive stages 62 makes it possible to easily adapt the configuration of the shoes 64 of the retaining means 6 by varying the articulation assemblies stage by stage, and this makes it possible to adapt the configuration of the retaining means 6 to various diameters D1, D2, etc. of packing sections, as illustrated in FIG. 7, where the dashed line illustrating the packing section 2 of a first diameter D1 have been left in order to facilitate the comparison between the dimensions of the packing sections 2 that are able to be gripped optimally when transferring, according to the invention, from one configuration to the other of the retaining means 6.

The adaptation of the position of the shoes 64 in relation to one another, and in relation to the platforms 63, within the retaining means 6 operates notably under the effect of the stress exerted when there is contact between the packing section 2 and the retaining surface 74 of the shoes 64, notably by way of a radial clamping movement of the retaining means 6, as was mentioned above.

It will be understood that the gripping of the packing section 2 by the retaining means 6 is possible if the retaining means are sufficiently radially separated in a first step, so as to pass around the peripheral edge 75 of the packing section 2, and if these retaining means 6 are then radially moved up so as to press against the peripheral edge 75. This radial movement in one direction and then in the other can notably be carried out by modifying the radial dimension of the deployment module 8 that contributes to forming the support 60 of the gripping device 100.

This radial movement can also be made possible by a motorized system 76, as mentioned above and illustrated schematically in FIG. 8.

As illustrated in this FIG. 8, the base platform 65 is fixed to the support 60 of the gripping device 100, in this instance formed by a peripheral member 10 of the deployment device 8 of the associated insertion device. A fixing block 77 has been illustrated schematically at the connection between the base platform 65 and the support 60 of the gripping device 100.

A motorized system 76 is disposed within the support 60 so as to be able to act on the base platform 65 and the fixing block 77, and exert a radial pushing force that tends to slide the base platform 65 away from the structure 60 and thus move the shoes 64 disposed opposite the structure farther towards the packing section 2.

The motorized system 76 may notably consist of a stepping electric motor.

The motorized system 76 can be employed to initiate the gripping operation, by moving the corresponding retaining means 6 radially away from and then moving it up to the packing section 2, and to finish the gripping operation by radially moving said corresponding retaining means away.

The motorized system 76 may also be used to generate a compressive stress specific to the corresponding retaining means, and thus enable, as described in detail above, a targeted compressive force on a given area of the peripheral edge 75 of the packing section 2.

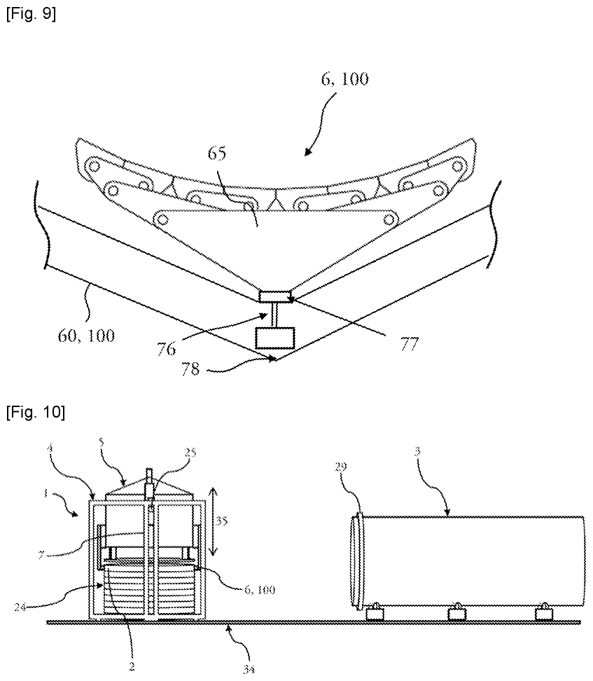

A variant of the invention is illustrated in FIG. 9, which differs from the above in that the support 60 in this case is common to all the retaining means 6. The support 60 has a polygonal, in this instance hexagonal, shape which at each vertex 78 has a fixing block 77 for fixing one of the retaining means 6 in a manner similar to what has just been described. A motorized system 77 is in this case particularly advantageous for modifying the radial position of the retaining means 6, in a context in which the support 60 has a fixed dimension.

Such a variant may notably be combined with a distinct and simplified pushing device to insert the packing section into the casing, as has been described above.

FIGS. 10 to 12 schematically illustrate an example of the progression of the method for inserting a packing section 2 according to the invention.

As has been described above, it is the insertion system 1 in its entirety, that is to say the insertion device 5 and the bearing structure 4, which makes it possible to implement the insertion method. FIGS. 10 to 12 illustrate the insertion method once the adjustment step has been completed, which is to say after the radial distance between the main member and the peripheral members of the deployment module has been determined and the retaining means are ready to grip the packing sections. Thus, FIG. 10 shows notably a step of gripping a packing section 2 on the vertical stack 24 of packing sections 2. For this purpose, the insertion system 1 can move in its entirety up to the stack 24 of packing sections, for example by means of rails 34 as mentioned above.

The insertion device 5 is able in its entirety to carry out a translational movement 35 with respect to the bearing structure 4, for example a translational movement along the pillars 7 in a vertical manner, that is to say in a manner parallel to the said pillars 7. This translational movement 35 may be brought about, for example, by the first motor 25 actuated remotely. This translational movement 35 is, for example, used in order that the insertion device 5 reaches the top of the vertical stack 24 of packing sections 2 and overhangs the latter, as is illustrated in FIG. 10. With this being done, and once the bearing structure 4 has been arranged around the vertical stack 24 of packing sections 2, the translational movement 35 makes it possible to move the insertion device 5 towards the stack 24 of packing sections 2 in order to grip the packing section 2 at the top of the said stack 24 via the retaining means 6. Once a packing section 2 has been gripped, the insertion device 5 is again moved in a vertical manner in order to raise the gripped packing section 2.

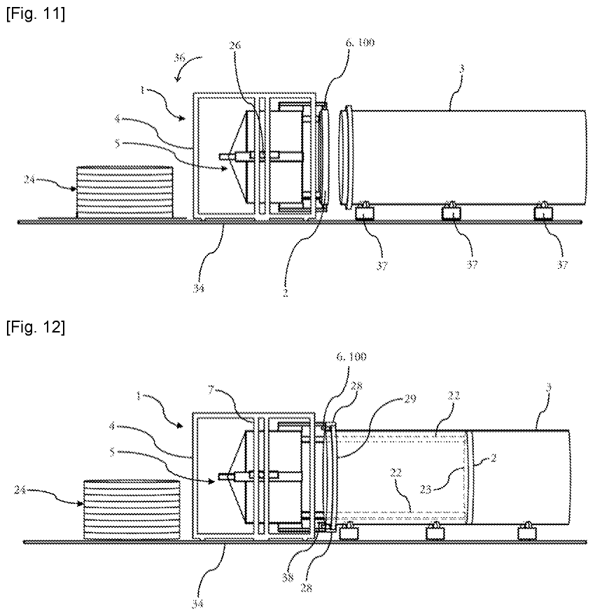

FIG. 11 illustrates a step of rotating the insertion device 5 and a step of moving the insertion system 1 up to the casing 3. These two steps occur after a packing section 2 has been gripped by the retaining means 6. In order to perform the step of rotating the insertion device 5 with respect to the bearing structure 4, the insertion device 5 comprises rotation-inducing means, here via the gear system illustrated in FIG. 1, performing at least one rotation 36 of 90° or substantially 90° of the insertion device 5 with respect to the bearing structure 4. The second motor 26 can be borne by the bearing structure 4 and controlled in such a way that the motor output shaft actuates the gear system and therefore the rotation 36 of the insertion device 5 with respect to the bearing structure 4. This rotation device driven by the second motor 26 thus makes it possible for the insertion device 5 to tilt between a first position, referred to as vertical, making it possible to grip the packing sections 2 on the stack 24 of packing sections 2, as is illustrated in FIG. 10, and a second position, referred to as horizontal, in order to arrange the gripped packing section 2 to face the horizontal casing 3, as is illustrated in FIG. 11.

Subsequently, the bearing structure 4 can move while bearing the insertion device 5 for the purpose of moving the gripped packing section 2 towards the casing 3 in order to insert it therein, for example by means of the rails 34 as mentioned above. In order to stabilize the casing 3, the latter may be arranged on supports 37.

FIG. 12 illustrates the step of positioning the insertion device 5 at the entrance to the casing 3 and also the step of pushing the packing section 2 into the casing 3. In order to correctly position the packing section 2 at the entrance to the casing 3, the vertical position of the insertion device 5 can possibly be adjusted by virtue of the vertical translational movement along the pillars 7 of the bearing structure 4 in order that the gripped packing section 2 perfectly faces the inlet of the casing 3. Once this has been done, the hooks 28 close over the flange 29 of the casing 3 in order to hold the insertion device 5 facing the entrance to the casing 3.

The pushing step starts after the retaining means 6 take a disengaging position for releasing the packing section 2. After the release of the packing section 2 by the retaining means 6 and before the telescopic devices 22 are deployed to insert the packing section 2, the latter can, for example, rest on a holding cradle 38 in order that the packing section 2 remains positioned correctly facing the entrance to the casing. The telescopic devices 22 then deploy so that the pushing means 23 inserts the packing section 2 into the casing 3, as has been described above. Once the insertion of the packing section 2 has been carried out, the telescopic devices 22 can retract, and the insertion system 1 can move again to recover the following packing section 2. The insertion method then recommences from the gripping step described in FIG. 10.

The invention, as it has just been described, does indeed achieve its stated objective and is able to propose a device for inserting a packing section into a casing, comprising retaining means 6 for ensuring the gripping of packing sections of different diameters. Variants that have not been described here could be implemented without departing from the context of the invention, provided that, in accordance with the invention, they comprise an insertion device according to the invention.

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

1. An insertion device configured to insert at least one packing section for a gas/liquid separation column into a cylindrical casing, the insertion device comprising a deployment module has a main member centred around a main axis of the insertion device, and a plurality of peripheral members arranged circumferentially and evenly around the main axis, each of the peripheral members contributing to forming the support of the gripping device, which has the support forming a chassis and retaining means connected to this support and distributed angularly so as to surround the packing section that is to be gripped, at least one of the retaining means having movable shoes respectively intended to be in contact with a peripheral edge of the packing section and a plurality of platforms disposed in at least two stages, each platform bearing articulation means able to interact with a platform of a different stage or one of the movable shoes, by bearing a respective one of the retaining means configured to grip a packing section, the deployment module being configured to modify the dimension of the insertion device in order to adjust the position of the retaining means around the packing section that is to be gripped, by modifying a radial distance between the main member and each of the peripheral members.

2. The insertion device according to claim 1, wherein the retaining means are arranged in relation to one another so as to form a circle, the said retaining means being evenly distributed angularly.

3. The insertion device according to claim 1, wherein the insertion device has six retaining means.

4. The insertion device according to claim 1, wherein each retaining means has a base platform which is connected to the support of the gripping device and bears an assembly of articulation means able to interact with first additional platforms forming a first stage of platforms of the gripping device.

5. The insertion device according to claim 1, wherein the first additional platforms each have articulation means able to interact respectively with second additional platforms, forming a second stage of platforms of the gripping device, or movable shoes.

6. The insertion device according to claim 1, wherein the movable shoes are mounted so as to be able to pivot on platforms of one and the same stage of platforms of the gripping device.

7. The insertion device according to claim 1, wherein the movable shoes have a retaining surface which can be inscribed in a straight plane.

8. The insertion device according to claim 1, further comprising a motorized system configured to drive the radial movement of the base platform, the motorized system being inserted between the base platform and the support of the gripping device.

9. The insertion device according to claim 1, wherein the support has the form of a polygonal frame, which has as many sides as the gripping device has retaining means, each retaining means being fixed on the inside of the support at a vertex of the polygonal frame.

10. A method for inserting at least one packing section for a gas/liquid separation column into a cylindrical casing, which method is implemented at least partially by an insertion device according claim 1, the method comprising the steps of:
adjusting the radial distance between the main member and the peripheral members of the deployment module;
gripping a packing section by the retaining means of the insertion device;
positioning the packing section at an inlet of the casing;
relaxing the grip on the packing section by the retaining means; and
pushing the packing section into the casing.
